(19) United States
(12) Patent Application Publication
(10) Pub. No.: US 2017/0200190 A1
(43) Pub. Date: Jul. 13, 2017

(54) DYNAMICALLY SERVED DIGITAL CONTENT BASED ON REAL TIME EVENT UPDATES

(71) Applicant: B3CONNECT, LLC, IRVINE, CA (US)

(72) Inventors: BRAD FRIEDMAN, COTO DE CAZA, CA (US); ALAN EDGETT, IRVINE, CA (US); BENJAMIN JACOB TILLY, LAKE FOREST, CA (US); MICHAL PLESZCZYNSKI, ASTORIA, NY (US)

(73) Assignee: B3CONNECT, LLC, IRVINE, CA (US)

(21) Appl. No.: 15/404,983

(22) Filed: Jan. 12, 2017

Related U.S. Application Data
(60) Provisional application No. 62/278,238, filed on Jan. 13, 2016.
(60) Provisional application No. 62/350,082, filed on Jun. 14, 2016.

(51) Int. Cl. G06Q 30/02; H04L 29/06; H04L 29/08

(52) U.S. Cl. CPC G06Q 30/0252; H04L 67/18; H04L 67/42

(57) ABSTRACT

A system and method for dynamically serving content to a client computer system. An events collection server retrieves event occurrence data elements. A data correlation server includes a query expander and a rules engine. A content server is receptive to a content request from the client computer system, and an initial query is passed to the query expander. The content server initiates one or more data lookup procedures, and tags converted from data returned from the data lookup procedures is added to the tag list, one of which is derived from the event occurrence data element. Content data facts are generated by the rules engine for return to the content server based upon a correlation of specific predefined combinations of the tags in the tag list. The content data facts correspond to at least one content data element retrievable by the content server for transmission to the client computer system.

### CROSS-REFERENCE TO RELATED APPLICATIONS

This application relates to and claims the benefit under 35 U.S.C. §119(e) to U.S. Provisional Patent Application No. 62/278,238 filed Jan. 13, 2016 and entitled “DYNAMICALLY SERVED DIGITAL ADVERTISING BASED ON REAL TIME SPORTS GAME EVENTS,” and to U.S. Provisional Patent Application No. 62/350,082 filed Jun. 14, 2016 and entitled “DYNAMICALLY SERVED DIGITAL ADVERTISING BASED ON REAL TIME SPORTS GAME EVENTS,” the entire contents of both of which are wholly incorporated by reference herein.

### STATEMENT RE: FEDERALLY SPONSORED RESEARCH/DEVELOPMENT

Not Applicable

### BACKGROUND

1. Technical Field

The present disclosure relates generally to networked computing and content delivery over computer networks, and more particularly, to dynamically served digital content based on real-time event updates.

2. Related Art

Producers of online content spanning various forms of text, image, audio, and video, which are the counterparts of traditional print new and magazine, radio, and television outlets, have developed extensive monetization strategies in order to support continued production and delivery efforts. The revenue thus generated is understood to offset the costs of server maintenance, network bandwidth, and other technical aspects, as well as the costs for producing the content itself, including compensation for the journalists, editors, and other personnel involved in production. Although payment from the reader/listener/viewer of such content is becoming increasingly common, the mainstay remains advertisements or paid promotional content that are embedded in or presented alongside the primary content.

There are a variety of ways in which these promotional messages can be integrated with the presentation of the primary content. The banner ad is the most common, which is a graphic designed by the advertiser and placed in a prominent location within the content by the publisher. A wide range of browser rendering techniques are used to present the promotional content, including embedding the banner in-line with the primary content but positioned on the top, side, or bottom ends of the page, displaying the banner in a separate static frame that does not move when the page is scrolled, and so forth. Besides static graphics, copy, calls-to-action, animations, sound, video and different interactive elements can be also be integrated into the banner. Clicking on the banner links the user to an online destination of the advertiser's choice, typically directing the user to the advertiser's website, where additional information and an opportunity to purchase the advertised product or service is provided. With video content, the banner may be overlaid on the video window so that its visibility is maintained. Banner ads may be utilized even for audio-only content such as podcasts and radio station simulcasts, as the streaming server client interface may still be presented on a conventional web page.

Other promotional content display techniques are also utilized. These include pop-up or pop-under windows that load the promotional content upon loading the primary content, floating displays that are overlaid on the primary content until some additional interaction (such as pressing a close button) is completed, and interstitial ads, which require a reader to view the promotional content before being provided access to the primary content.

The payment to the content provider in exchange for presenting the advertisements is based upon one or more well-known metrics. One is based upon the number of times the advertisement was displayed to a viewer, similar to the way payment for print advertisements are derived from total circulation counts. This is referred to as Cost-Per-Mille (CPM), or the cost per thousand impressions. Additional restrictions may be imposed on what constitutes a proper, countable delivery of the promotional content. One tracks the number of times the advertisement is clicked to access the advertiser's site, referred to as Cost-Per-Click (CPC). Still further, the number of times the advertisement is clicked and a desirable action is taken such as completing a registration form or a purchase may be the utilized metric, referred to as Cost-Per-Action (CPA).

Unlike traditional media in which the content provider exercises exclusive control over the selection and presentation of advertisements, with online advertisements, the advertisers and content providers rely upon a third party advertising delivery servers, networks, and other advertising technology based systems. One value-added function of such advertising technologies is tracking the metrics for the advertisements served, and paying the content producer in accordance therewith. The advertising technology also optimizes the delivery of the promotional content.

With regard to aesthetics, the advertising technology may enforce dimensional restrictions on the advertisement graphic that is received from the advertiser or advertising agency. The content producer may define a specific layout within such constraints so that any promotional content, so long as it fits within the dimensions, will be presented consistently in the designated space. The advertising technology may specify other limitations with respect to the graphics of the promotional content.

The indiscriminate delivery of promotional content without regard to the tastes, interests, desires, and current circumstances of the audience to which it is presented tends to be wasteful and yield lower response rates. Accordingly, the advertiser may be able to provide keywords or other metadata to the advertising technology, and specify a contextual relationship to the content producer and/or the specific primary content together which the promotional content is presented. For example, a keyword of “sports” may be associated with the promotional content, and only to the extent the content producer includes a descriptor or tag of “sports,” would such promotional content be displayed. The delivery of the promotional content may also be optimized for the specific reader/listener/viewer based upon past actions, current geographic location, and other like data points that may be tracked by the advertising network. Some advertising technologies function as exchanges, with multiple advertisers bidding on one or more keywords to provide preferential access to the limited space in the primary content layout, as well as increased compensation to the content producer for such privilege.

Although tying the promotional content to particular keywords, past user actions, and so forth help to refine its targeting, such defined associations are static once the campaign is launched. The content of the advertisements is not adjustable in real time according to quickly changing circumstances, such as major sporting events where two closely matched teams are competing against each other. Furthermore, in order to advertise to specific subsets of fans with a specific subset of outcomes, currently it is necessary for the advertiser to produce separate creatives/content for each. Thus, there is a need in the art for dynamically serving digital content based on real-time event updates.

### BRIEF SUMMARY

The present disclosure is directed to serving dynamic content based upon a combination of audience data, live event updates, and other data feeds. The dynamic content may be customized and continuously updated with live data from ongoing events and specifically defined creative conditions. The system is configured for scalability, and the content may be served either over the Internet, or from replicas delivered through content delivery networks. In one contemplated embodiment, the content may be advertisements that change according to events that occur in real-time during a sporting event/game of interest to the audience. Although the various embodiments are disclosed in the context of sporting events, this is by way of example only and not of limitation. The embodiments are understood to be applicable in other contexts, including those relating to entertainment, news, and live events such as concerts, movie premieres, and the like. Generally, the system is envisioned to dynamically decide whether to display content or advertisements, which content or advertisements to display, and dynamically insert graphics, copy, calls-to-action, animations, sound, video and different interactive elements based on real-time data into content or advertisements.

In accordance with one embodiment of the present disclosure, there is a system for dynamically serving content to a client computer system. The system may include an events collection server. One or more event occurrence data elements may be retrievable by the events collection server. The system may also include a data correlation server with a query expander and a rules engine. There may also be a content server that is receptive to a content request from the client computer system. An initial query may be generated by the content server and passed to the query expander of the data correlation server. The initial query may include at least one tag generated as a function of the content request and may be stored in a tag list. The content server may initiate one or more data lookup procedures including on the events collection server as generated by the query expander. One or more tags converted from data returned from the data lookup procedures may be added to the tag list, with at least one of the tags being derived from the one or more event occurrence data elements retrieved by the events collection server. One or more content data facts may be generated by the rules engine for return to the content server based upon a correlation of specific predefined combinations of the tags in the tag list thereto. The one or more content data facts may correspond to at least one content data element retrievable by the content server for transmission to the client computer system.

Another embodiment of the present disclosure is a method for dynamically serving content to a client computer system. The method may include receiving a request for a content data element from the client computer system. Additionally, there may be a step of generating a tag list from the received request for the content data element. The tag list may include at least one tag. The method may include transmitting an initial query with the initial tag list to a data correlation server. In response to the initial query, the data correlation server may generate one or more data lookup procedures. The method may continue with initiating the execution of the one or more data lookup procedures. At least one of the data lookup procedures may be executed on an event collection server with one or more event occurrence data elements retrievable thereby. The one or more data lookup procedures may return data convertible to one or more tags for storage on the tag list, with at least one of the tags being derived from the one or more event occurrence data elements. The method may further include transmitting the tag list to the data correlation server. One or more content data facts may be generated by the data correlation server based upon a correlation of specific predefined combinations of the tags in the tag list thereto. There may also be a step of retrieving content data elements corresponding to the one or more content data facts, followed by transmitting at least one of the content data elements to the client computer system.

Certain other embodiments of the present disclosure contemplate respective computer-readable program storage media that each tangibly embodies one or more programs of instructions executable by a data processing device to perform the foregoing method. The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram depicting an exemplary networked computing environment in which various embodiments of the system for dynamically serving digital content may be implemented;

FIG. 2 is a block diagram illustrating the functional inter-relationships between the components of the system for dynamically serving digital content;

FIG. 3 is a sequence diagram of the steps performed by and between the components of the system for dynamically serving digital content;

FIG. 4 is a flowchart depicting one embodiment of a method for dynamically serving digital content in accordance with the present disclosure; and

FIG. 5 is a detailed block diagram showing the components of the system for dynamically serving digital content based on real-time event updates.

### DETAILED DESCRIPTION

The detailed description set forth below in connection with the appended drawings is intended as a description of certain embodiments of systems and methods for dynamically serving content. It is not intended to represent the only forms of these methods that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as first and second and the like are used solely to distinguish one entity from another without necessarily requiring or implying any actual such relationship or order between such entities.

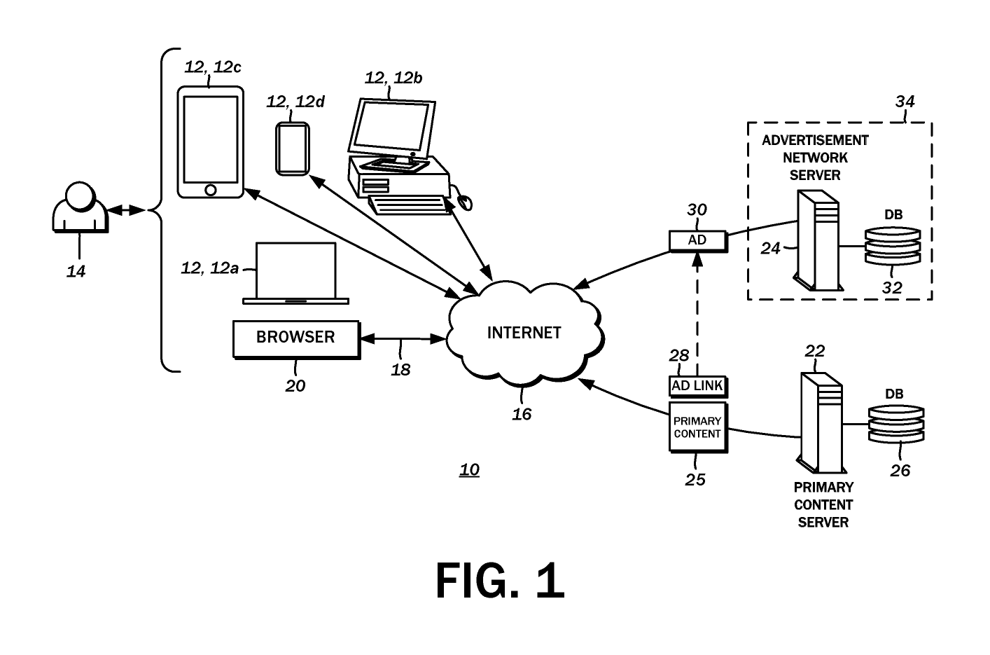

Referring now to the block diagram of FIG. 1, one embodiment of the present disclosure may be implemented in the context of an exemplary networked computing environment 10. In a basic configuration, there is a client computer system 12 operated by a user 14 and is connected to the Internet 16 over a first data communications link 18. Though depicted in a laptop/notebook form factor, the client computer system 12a is understood to be a general purpose computer device including a central processing unit, memory, and various input and output devices such as keyboards, mice, and displays. Additionally, the client computer system 12 is understood to include network interface devices such as a Wi-Fi module, an Ethernet module, and the like to establish the first data communications link 18 to the Internet 16. Other computing devices in different form factors such as desktop computers 12b, tablet computers 12c, smart phones 12d, smart TVs, and the like may be readily substituted, however.

Regardless of the form factor, the client computer system 12 is understood to have executable instructions of a web browser application 20 that is loaded thereon. The web browser application communicates with various web servers connected to the Internet 16 over the hypertext transfer protocol (HTTP), among other protocols known in the art. In the exemplary networked computing environment 10, there is a primary content server 22, as well as an advertisement network server 24. Requests for content are initiated by the client computer system 12 and transmitted to these servers, while the requested server responds with a transmission of the requested content back to the client computer system 12. The operational principles of web servers, web browser applications, and the Internet 16 are well understood, so no further details will be discussed herein. The present disclosure references the web browser application 20 and web servers 22, 24, but it will be appreciated that there may be some embodiments where such an application or protocol is not utilized. Accordingly, as referenced herein, the web browser application 20 is understood encompass any other client application that interacts with various servers connected to the Internet 16 to exchange data.

Continuing with the example of the primary content server 22, the web browser application 20 is understood to generate a request for a primary content element 25 that may be served by the primary content server 22. There may be a separate primary content database 26 on which the primary content element 25 is stored, but it is understood that the web browser application 20 makes the request to and receives the responsive primary content element 25 from the primary content server 22. As noted herein, the primary content element 25 is understood to be any content, including text, graphics, audio, video, or any combination thereof. Examples of the primary content element 25 include news articles, blog posts, event highlight clips, and so on.

In many cases, embedded within the primary content element 25 is an advertisement that, upon being viewed, clicked, or otherwise engaged with, compensates the owner of the primary content elements 25, e.g., the operator or owner of the primary content server 22. More particularly, the primary content element 25 includes an advertisement link 28 with a specific network address of an advertisement 30 that is served by the advertisement network server 24. The advertisement 30 itself may be stored in an advertisement database 32, but again, the request is made to the advertisement network server 24 and the request is responded to from the same.

As will be recognized by those having ordinary skill in the art, the web browser application 20 first requests the primary content element 25 from the primary content server 22. In response, the primary content server 22 serves the primary content element 25 to the client computer system 12, and the web browser application 20 begins the rendering process. As the advertisement link 28 is processed, the web browser application 20 generates a subsequent request to the advertisement network server 24 in order to retrieve the advertisement 30. The advertisement network server 24 responds with a transmission of the advertisement 30 back to the web browser application 20 for rendering thereby.

Those having ordinary skill in the art will recognize that the foregoing description of the online advertisement serving process is greatly simplified. More sophisticated advertisement serving are possible, and the advertisement network server 24 may include additional modalities by which different advertisements 30 or types of advertisements may be specified via parameters embedded in the advertisement link 28. Furthermore, the advertisements 30 may be tailored to preferences of the user 14 as defined in persistent data stored within the web browser application 20. The present disclosure contemplates a system 34 for dynamically serving content, which may include, inter alia, the foregoing advertisement network server 24 and the advertisement database 32.

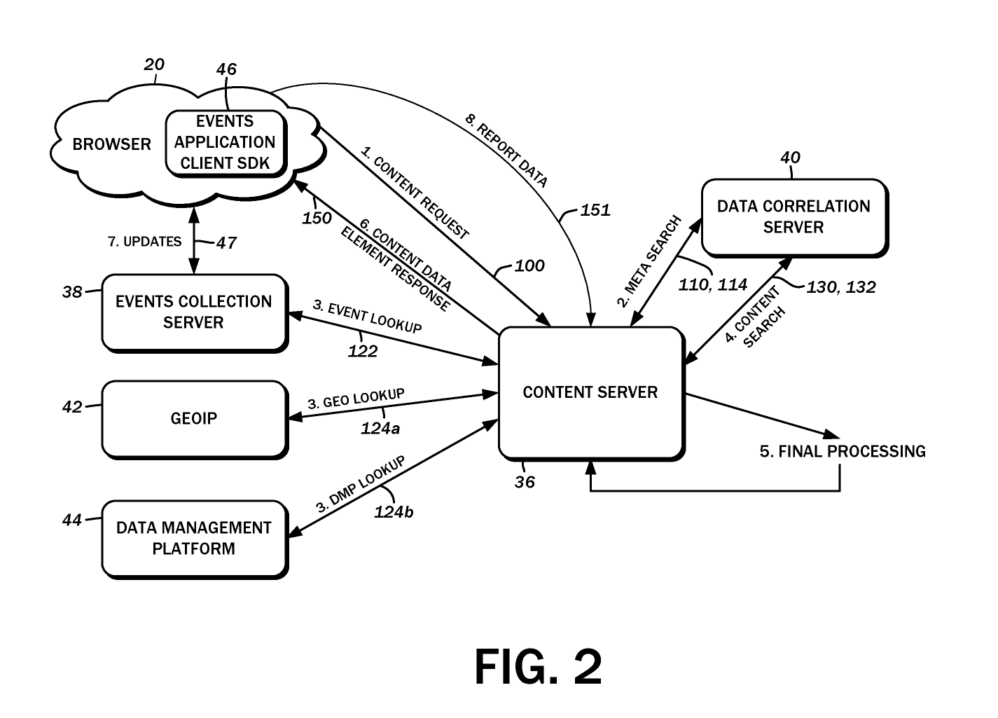

Referring to the block diagram of FIG. 2, one embodiment of the system 34 includes a content server 36, an events collection server 38, and a data correlation server 40. In this context, the content server 36 is understood to be different from the aforementioned primary content server 22, and is more akin to the advertisement network server 24. Content, as referenced in the various exemplary embodiments, may be the advertisement 30, though any other type of content may be substituted without departing from the scope of the present disclosure. Accordingly, the content server 36 may, in some embodiments, be referred to as an advertisement server. The present disclosure contemplates serving different advertisements 30 or content depending on certain real-time events that are recorded in the events collection server 38. As will be described in further detail below, the data correlation server 40 can match the content to specific, ongoing events, that is, more relevant advertisements 30 can be served.

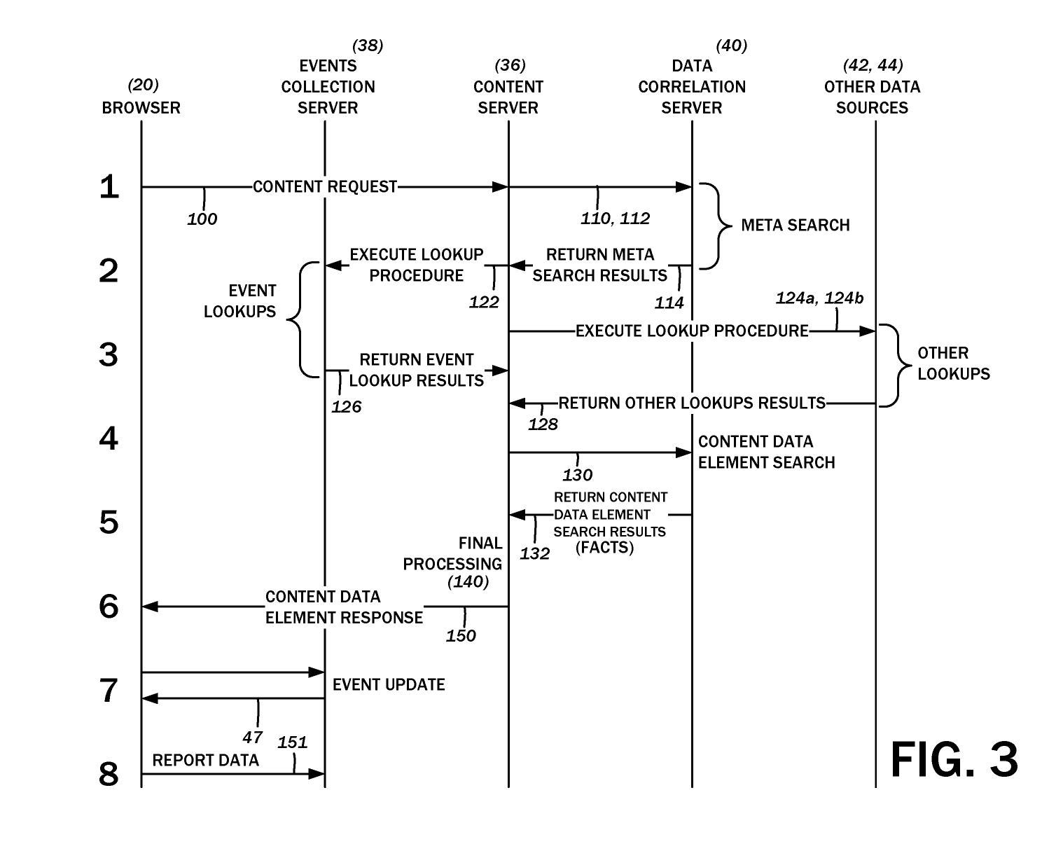

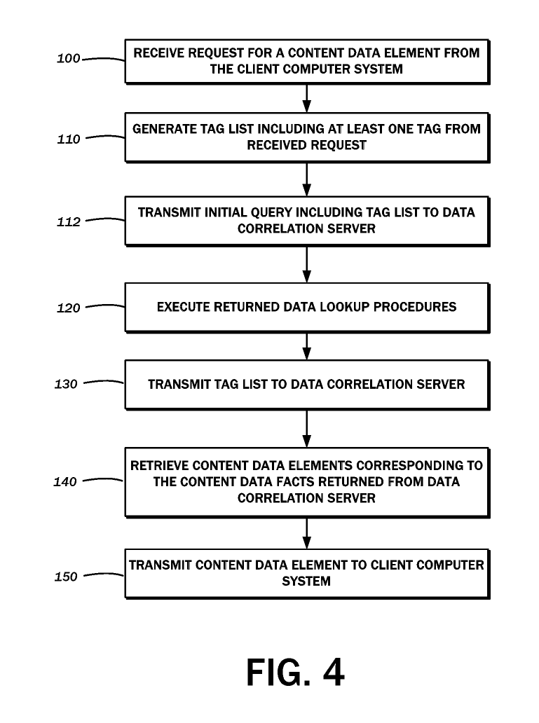

Another embodiment of the present disclosure is directed to a method for dynamically serving content, e.g., advertisements, to the client computer system 12. The sequence of steps in this method relative to the aforementioned content server 36, the events collection server 38, and the data correlation server 40 are further illustrated in the sequence diagram of FIG. 3. The methodology from the perspective of the content server 36 is generally described in the flowchart of FIG. 4. As in conventional advertisement serving techniques, the method begins with receiving a request for the content data element, e.g., the advertisement 30 in a first step 100. This request is understood to be generated by the web browser application 20 as described above.

The content server 36 receives the request, and the passes it to the data correlation server 40. More particularly, the content server 36 generates an initial list of tags and stores them in a tag list in accordance with a step 110. The tags are generated from the received request for the content data element. Once generated, the tag list is transmitted to the data correlation server 40 in accordance with a step 112 as an initial query. This initial query may be referred to as a meta call, and is operative to search the data correlation server 40 for facts regarding what additional data queries are needed. As referenced herein, a tag refers to short text strings that represent known facts about a request. In one exemplary implementation, a tag may comprised of an attribute-value pair such as “gender:male”, where gender is the attribute and male is the value. Other examples include specifying Zip codes and cities thus: “zip:02112” and “city:Boston.” In one contemplated embodiment, this data may be stored in accordance with the JavaScript Object Notation (JSON) data format, though it will be appreciated by those having ordinary skill in the art that any other suitable format may be substituted.

Also as referenced herein, a fact refers to data items that are tied or correlated to a combination of tags. Like the tags themselves, a fact is also stored in accordance with the JSON data format. For example, the tags (“gender:male”,“city:boston”) may correspond to a fact {“ad”:“1324”}. That is, if the gender of the user 14 initiating the request is male and lives in the city of Boston, then present an advertisement with the identifier “1324.” Furthermore, an additional tag may be added to the original combination thus: (“gender:male”, “city:boston”, “saw_ad:1324”), where “saw_ad” is an indicator that the advertisement with the identifier “1324,” has already been seen. A fact correlated to this particular combination may be {“block”:“1324”}, that is, do not show the advertisement with the identifier “1324,” as it has already been presented. It is understood that the same fact may be stored for many different combinations of tags.

As indicated above, the meta search returns one or more data lookup procedures to be executed by the content server 36, which takes place in a step 114. Referring again to the flowchart of FIG. 4, the method continues in a step 120 of executing the returned data lookup procedures, with at least one of the data lookup procedures being executed on the events collection server 38 according to a step 122b. In some embodiments, the data lookup procedure may not be needed to the extent content not dependent thereon is to be served. In accordance with various embodiments of the present disclosure, the events collection server 38 stores real-time event data retrieved from a third party service. There are a variety of vendors and data providers known in the art, and the information from any such provider may be stored on the events collection server 38 for further use. In some cases, the real-time event data, also referred to as event occurrence data elements, may be refreshed every four seconds. However, this may be customized, and any other refresh rate may be readily substituted. In the sporting event context, the event occurrence data elements may be categorized and stored on a game-by-game basis, and indexed according to game and event identifiers. The data lookup procedure is understood to return one or more tags that are derived from the event occurrence data elements.

In addition to executing the data lookup procedure on the events collection server 38, another data lookup procedure may be executed on a network address-based geographic locator 42 in a separate step 124a. The network address-based geographic locator 42 is understood to retrieve the network (IP) address of the client computer system 12, and derive a geographic location that is associated with that particular address, or address block. Typically, such lookups are capable of returning location information as narrow as the city-level, though others are also possible, e.g., by state, or by country.

Yet another data lookup procedure may be executed on a data management platform (DMP) 44, which is understood to be a digital advertising data aggregation system in which first party and third party audience data pertaining to advertising campaigns are collected. This procedure is shown as a step 124b.

Each of the foregoing data lookup procedures are executed in parallel, and return one or more of the tags to the content server 36. The three specific examples relating to the execution of the data lookup procedures have been presented, but these are not intended to be limiting. Additional data lookup procedures may be executed on other databases. The data returned from the data lookup procedures may be converted to additional tags from the events collection server 38 are returned in a step 126, while the tags from the network address-based geographic locator 42 and the DMP 44 are returned in a step 128. Each of the returned tags are saved into the aforementioned tag list.

The content server 36 then transmits the tag list to the data correlation server 40 in a step 130. The data correlation server 40 then generates one or more content data (advertisement) facts based upon a correlation of specific predefined combinations of the tags in the tag list. The data correlation server 40 maintains an internal taxonomy of tags, in which additional tags are implied from existing tags organized specifically to correlate with the sports specific event collection server 30 by Sport, League, and Team (i.e. Baseball, Major League Baseball, Boston Red Sox). Following receipt of the tags transmitted in step 130, the data correlation server 40 performs a taxonomy expansion. For example, if “zip:02112” is provided, then “city:Boston” is implied. Furthermore, “city:Boston” implies “team_geo:Red_Sox” (that is, the Boston Red Sox baseball team). In turn, the Red Sox baseball team tag implies “leage_geo:baseball”. This internal taxonomy is recursively expanded in accordance with the present disclosure, and additional tags are generated and stored in the tag list. If an expanded tag can be arrived in multiple ways, the union of the values is utilized in the context. For example, in a baseball game where the Mets are playing the Dodgers, the tag “playing_sport:baseball” may have a match context of {“team: [“mets”, “dodgers”] }.

As indicated above, from the list of tags, the data correlation server 40 generates facts that are associated with subsets of the tags. In one embodiment, the tags to facts relationship is stored in a trie data structure, with the tags being in sorted order. A search for the facts involves sorting the tags, then recursively searching the trie for all combinations of the tags in the tag list that match any of the facts. Thereafter, the facts are assembled into a list. The trie data structure and the procedures involved in sorting and searching the same are well known in the art, so the details thereof will be omitted.

In some cases, the tags have an associated match context. For example, “team_geo:red_sox” is understood to have a context of {“team”:[“red_sox”]} with low confidence. When such tag is encountered during taxonomy expansion, the context is associated with the tag, and inherited up the taxonomy structure. As referenced herein, match context is understood to be a discovered context during the matching process, and may be stored as an attribute/value pair in the JSON data format. Continuing with the foregoing baseball game example, an particular content data element may be designated as being applicable for a game played between the Mets and the Dodgers, and may be specified thus: {“team”:[“mets”, “dodgers”]}.

The values in the match context of a set of tags may be the intersection of the values of the individual match context. To the extent the intersection is empty, a match is not found. For example, if a content data element or advertisement 30 is targeted to a game of baseball, (which may be discovered through taxonomy expansion of the Mets team and the Dodgers team) but if the user 14 is neither a fan of the Mets or the Dodgers, and is a fan of the Red Sox, that advertisement would not be presented.

A confidence level may also be associated with the facts in the match context during taxonomy expansion. When a context is inherited up the trie structure upon expansion, the contexts of equal confidence may be merged, while the lower confidence information may be dropped. However, during the subset match, the confidence level may be ignored. Accordingly, it is possible for the data correlation server 40 to combine various categories of information regarding the user's interests, and using the most pertinent source to make decisions on how to present different content data elements/advertisements 30.

In a step 132, the content search results, e.g., the facts based on the tags provided and expanded upon in the data correlation server 40, are returned to the content server 36. There, a final processing procedure takes place, including a step 140 of retrieving the content data elements corresponding to the one or more content data facts returned by the data correlation server 40. The content data facts are understood to pertain to which content data elements/advertisements 30 are available, blocked, and so forth. The facts are organized according to the content data element, and the available content data elements are determined. The information from the match context, particularly that pertaining to the matching teams and games for which it may be served can be injected into the content data element/advertisement 30. Other information from the match context may also be injected into the content data element.

The various interactions between the content server 36, the events collection server 38, and the data correlation server 40 may be facilitated through application programming interfaces (APIs) that can be called either locally or over the Internet 16 using standard protocols, including HTTP. As will be explained further below, the APIs may be served from a single production server, or from a dedicated replica that is co-located with a client to ensure low latency.

Another final processing procedure involved filtering by creative conditions. As referenced herein, creative conditions is understood to refer to specific conditions that occur during the course of an event for which a specific creative can be delivered. Again, in the context of the sporting event, when the home team scores, a creative condition is met, and a specific content data element/advertisement 30 that matches it may be served (e.g., that the user should celebrate the scoring by having a drink produced by the advertiser, etc.).

Of the remaining content data elements, the best remaining one may be selected for transmission to the client computer system, which occurs in a step 150. Prior to transmission, the content data element, and specifically any macros included therein, with information derived from the tags, such as an identifier of the game of interest, or the team playing such game. The content data element may also include a data update client 46 that is executable on the client computer system 12 and communicates with the events collection server 38. On a periodic basis, the data update client 46 retrieves updates 47 to the events occurrence data elements stored in the events collection server 38, which in turn is used to modify data within the content data element. In accordance with one embodiment the data update client 46 may be implemented as a Java servlet. This is presented by way of example only and not of limitation, and the data update client 46 may be implemented in any language/technology that is capable of consuming JSON structured data through the HyperText Transfer Protocol (HTTP) or Secure HTTP (HTTPS) Updates to other information may be retrieved by the data update client 46.

At any point after transmitting the content data element to the browser application 20 and it is received thereby, the browser application 20, in turn, may report various data back to the content server 36 in a step 151. This data includes the advertising impression itself (the fact that it was viewed/presented on the browser application 20), the time, the Internet Protocol (IP) address of the client 12, the actions taken by the user in relation to the content, and so on.

In the embodiment of the system 34 configured specifically for presenting advertisements 30 associated with specific game events, the context matching performed by the data correlation server 40 involves the dynamic determination of the appropriate game and team to show in the advertisement 30. One advertisement creative may be customized across many different games and teams, and the content server 36 is capable of combining this information with the event occurrence data from the events collection server 38 to match the state of the game with the advertisement 30 that is presented to the user 14. Moreover, complex creative conditions such as whether the user's favored team is in the lead or losing may be evaluated before delivering the advertisement 30, and tailoring the contents thereof to such creative conditions. These creative conditions may be defined in terms of if/then statements that allow the creative to change dynamically. With the advertisement 30 being rendered within the web browser application 20 and the data update client 46 running, information presented in the advertisement 30 can be updated with the latest live data available for a particular game. Other third party application programming interfaces may be queried to obtain separate, though contextually related information such as ticket prices for future games of the team.

The functionality of the system 34 as described above may be invoked from the web browser application 20 in a manner similar to the more basic implementation of serving online advertisements shown in FIG. 1, where the primary content 25 includes an advertisement link 28 to an advertisement 30 that is retrieved via the advertisement network server 24. In one implementation, a browser executable script, which may be incorporated into the events application client SDK 46, may be utilized. One exemplary embodiment of the script, which in an exemplary embodiment is written in JavaScript, is as follows:

<script src=”//w.amazonaws.com/fanserv-static/tags2.min.js”></script>
<script>(new FanServTag({

host:’//adserver.fanserver.net’
mediaType:’html’.
mediaCategory: ‘banner’,
size: ‘300x250’,
appId: ‘fd2193bcac144c2eb3ca9d3964985103’

})).loadAd( );</script>

The advertisement 30 that includes the specific content customized in accordance with the present disclosure may be invoked with a single tag or call as shown. The foregoing script instantiates a new object FanServTag with parameters for the host, media type, media category (which is specified as “banner”), and the size of such banner. The appId parameter specifies the specific campaign, the advertising creative, etc. for which this invocation of the new FanServTag object is to apply. The various tags, match context, and so on for a set of advertisements is associated with this identifier on the content server 36. This represents one technical solution to the conventional limitations of defining multiple tags for each subset of fans and each subset of outcomes that would otherwise be necessary for presenting specific advertisement content, and replaces such multiple tags with a single tag.

Thus, the presently disclosed system 34, and the method described herein, are contemplated to be one technical solution to the limited static nature of advertising content once a campaign is launched. Thus, the system 34 may adjust, in real-time, the content of the advertisements 30 based on quickly-changing circumstances in an event, and duplicative content need not be generated to address many possible events as the content may be updated from available event data.

Various use cases are contemplated for the system 34 as described above. Again, it is envisioned that the system 34 serve advertisements 30 in line with other content that are closely related to ongoing, real-time events. For example, depending on the events that occur in the course of a sporting event/game specifics within the advertisement 30 itself may be modified or adjusted accordingly. Additionally, live event data may be incorporated into the advertisement 30, such as one that is generally targeted to basketball fans showing the most updated score in a game being played by one or both teams of interest to the user, or some action occurs involving a player of interest to the user in one of the teams. It is possible to provide content along the lines of, for example “Tune in now! The Lakers are beating the Celtics 102-98 and Russell has a triple double!”

The content of the advertisements 30 may be modified based on various creative conditions, an example of which is if Team A (of which the user is a fan) scores a goal, and is leading the game, the advertisement 30 may display a message along the lines of “We're winning!” On the other hand, if the team's lead was lost as a result of the opposing team scoring a goal, another message along the lines of “We're losing!” can be incorporated into the advertisement 30.

The system 34 is also envisioned to serve advertisements 30 that are highly context-sensitive and targeted specifically to particular users or groups of fans/users. That is, the right advertisement 30 is delivered to the right fan, in the right market. For example, it is possible for a retailer (for the sake of example, a retailer of sporting goods) to run a national advertising campaign, but only serve advertisements for particular clothing items, e.g., jerseys, emblazoned with logos for a particular team, e.g., the Broncos, and only in the potential market of interest, e.g., Denver, the home city of the Broncos. That same advertising campaign may further specify serving advertisements for jerseys emblazoned with the Cowboys logo only in Dallas. Other limitations for particular advertising campaigns may similarly be targeted according to parameters as specified by the advertiser. The delivery of the advertisements 30 may also be targeted to fans of a specific team only when the team(s) of interest to the fan is currently playing in a game. Similar to the way in which creative conditions may be set to modify the content of the advertisements 30 themselves, different creative conditions may also be set to serve advertisements at a specific time based on uniquely defined if/then conditional parameters.

The configuration of the system 34 in which the procedures for determining which advertisements 30 to present based upon the event occurrence data elements are decoupled from the content server 36 is understood to allow for the integration of any data source. In addition to the network address-based geographic locator 42 and the data management platform 44 discussed above, the data lookup procedures may be executed on other data sources such as weather services, and the like. By way of example, weather data in the vicinity of the stadium in which the game of interest is being played may be used to generate targeted advertisements 30 to those watching the game in inclement weather. In accordance with various embodiments, the external application programming interface to such a data source would be called when an advertisement correlated to a specific tag/fact based upon this data becomes available.

Although a specific sequence of steps performed by the content server 36, the events collection server 38, and the data correlation server 40 have been described, those having ordinary skill in the art will recognize that sequence may be modified in various ways. For example, the data lookup procedures may be executed sequentially instead of in parallel, though potentially at the expense of slower delivery of the content data element. Only active events may be queried through the data lookup procedures executed on the events collection server 38, while the content search may be performed only once. While the present disclosure defined particular functionalities as being performed by one of the content server 36, the events collection server 38, or the data correlation server 40, this is also by way of example only. The system 34 may be modified such that any given function may be performed by a different server than that described herein.

Along these lines, the specifics of the data correlation server 40 and the functions performed thereby are likewise presented by way of example, and specific to one embodiment of the system 34. Alternative embodiments are also envisioned, such as utilizing a complex Structured Query Language (SQL) query being used to determine which advertisements 30 are tied to a currently ongoing event/game, followed by an external filter based upon the user's interest in a given team or game. This is understood to be a simpler solution that tailors the advertisements 30 being served to a specific team, but adapting to more complex use cases is understood to be more challenging with such a configuration. Additionally, different versions of the advertisement 30 may be stored for each possible outcome, then utilizing a recommendation engine to find an advertisement of interest with an associated context. However, a much larger data structure would likely be necessary.

As discussed above, the content data elements served by the content server 36 is not limited to the advertisements 30 of the exemplary embodiments disclosed herein. For example, it may be possible to incorporate dynamic display video clips of recent play-by-play events into an external video stream. In addition to the web browser application 20, other automated data processing applications may cooperate with the application programming interface to the system 34 to incorporate dynamic content.

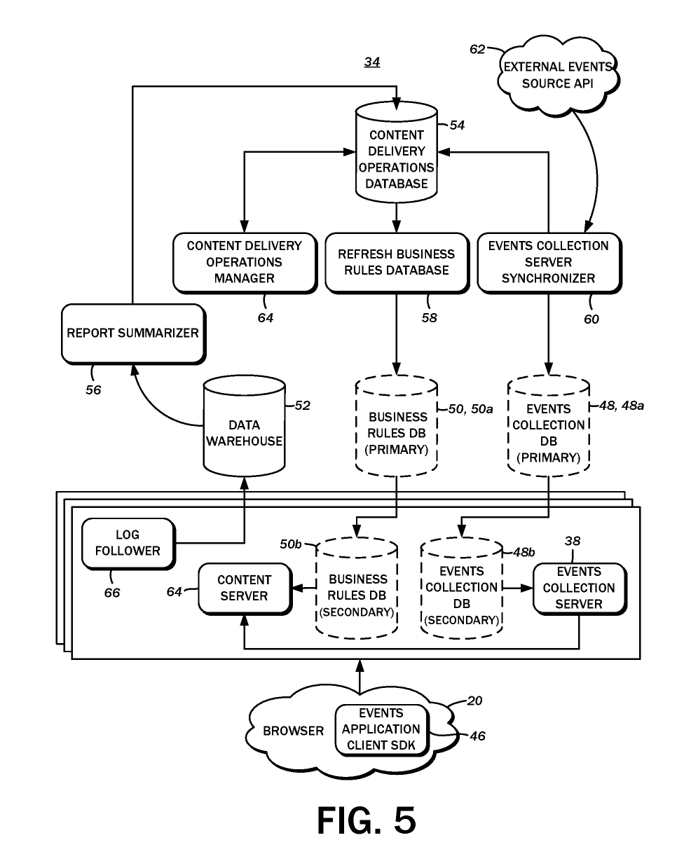

The events collection server 38 and the data correlation server 40 uses and manages data that is stored in respective databases in order to generate the responses to the requests from the content server 36. With additional reference to the block diagram of FIG. 5, the events collection server 38 is connected to and cooperates with an events collection database 48, while the aforementioned data correlation server 40 is understood to be connected to and cooperates with a business rules database 50.

In order to manage and administer the aforementioned components of the system 34, there is a data warehouse database 52, and a content delivery operations database 54. These databases and data stores, including the events collection database 48, the business rules database 50, and the data warehouse database 52 are synchronized by a report summarizer 56. Additionally, there is a function 58 to refresh the data correlation server 40, and specifically the data store therefor, e.g., the business rules database 50.

The events collection database 48 cooperates with an events collection server synchronizer 60, which is also cooperates with an external events source application programming interface 62 that connects to a third party live sports events data source. The data retrieved therefrom is stored in both the events collection database 48 and the content delivery operations database 54. Additionally, the events collection database 48 is utilized by the data correlation server 40 to define specific limits such as campaign/flight limits, serving the content in a chain, and serving the content according to a set pacing, and so forth.

A content delivery operations manager 64 is used to create and schedule campaigns that can be used to serve the advertisements 30, and to power the various application programming interfaces contemplated in accordance with the embodiments of the system 34. The content delivery operations manager 64 is connected to and stores the data utilized thereby to provide its functionality in the aforementioned content delivery operations database 54.

Various embodiments of the present disclosure contemplate replicating the data in the events collection database 48 and the business rules database 50 for maximum scalability and fault tolerance. The web servers utilizing these databases, that is, the content server 36, the events collection server 38, and the data correlation server 40 can continue to respond to client requests when other components of the system 34 are offline. The databases may be replicated to a third party content delivery platform. In further detail, the primary events collection database 48a is replicated to a secondary events collection database 48b, while the primary business rules database 50a is replicated to a secondary business rules database 50b. Multiple replication instances are possible to handle higher loads. The replication of the databases is optional, however, and some embodiments contemplate the web servers connecting directly to the respective primary databases. Still other embodiments contemplate storing the data in a distributed NoSQL system. Any other suitable fault tolerant system may be readily substituted without departing from the scope of the present disclosure.

A log follower process 66 saves campaign data, that is information pertaining to impressions, click-throughs, and so forth, as to specific advertisements 30, to the data warehouse database 52. The aforementioned remote summarizer 56 is also understood to analyze such information on a periodic basis, and updates the content delivery operations database 54 to track the progress for those campaigns nearing caps and the like.

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details of the present disclosure with more particularity than is necessary, the description taken with the drawings making apparent to those skilled in the art how the several forms of the present disclosure may be embodied in practice.

What is claimed is:

1. A system for dynamically serving content to a client computer system, the system comprising:
an events collection server, one or more event occurrence data elements being retrievable by the events collection server;
a data correlation server including a query expander and a rules engine; and
a content server receptive to a content request from the client computer system, an initial query being generated by the content server and passed to the query expander of the data correlation server, the initial query including at least one tag generated as a function of the content request and being stored in a tag list, the content server initiating one or more data lookup procedures including on the events collection server as generated by the query expander, one or more tags converted from data returned from the data lookup procedures being added to the tag list, with at least one of the tags being derived from the one or more event occurrence data elements retrieved by the events collection server;
wherein one or more content data facts are generated by the rules engine for return to the content server based upon a correlation of specific predefined combinations of the tags in the tag list thereto, the one or more content data facts corresponding to at least one content data element retrievable by the content server for transmission to the client computer system.

2. The system of claim 1, wherein the content server includes a secondary condition filter, selected ones of the at least one content data element being excluded from transmission to the client computer system based upon an evaluation of secondary conditions associated therewith.

3. The system of claim 1, wherein a confidence level is assigned to the at least one tag generated as the function of the content request.

4. The system of claim 3, wherein the tags returned from the data lookup procedures inherit the confidence level of the at least one tag from which it was generated.

5. The system of claim 1, wherein the content server appends data associated with one of the tags in the tag list to the content data element transmitted to the client computer system.

6. The system of claim 1 wherein the content server appends a data update client executable on the client computer system for communication with the events collection server, the content data element transmitted to the client computer system being modified by the data update client in response to an update to the one or more event occurrence data elements received thereby from the events collection server.

7. The system of claim 1, further comprising:
a content database with the one or more content data elements being stored thereon, the content server being in communication with the content database to retrieve the one or more items of digital content.

8. The system of claim 1, further comprising:
an events collection database with the one or more event occurrence data elements being stored thereon, the events collection server being in communication with the events collection database.

9. The system of claim 8, further comprising:
an events synchronization interface to an external events source, the event occurrence data elements as generated by the external events source being stored into the events collection database with the events synchronization interface.

10. The system of claim 1, further comprising:
a content database with the one or more content data elements being stored thereon;
an events collection database with the one or more event occurrence data elements being stored thereon; and
a database replicator that copies the content database and the events collection database to secondary instances thereof, the content server and the event collection server being in communication with the secondary instances of the respective one of the content database and the events collection database.

11. The system of claim 1, wherein the content server initiates one or more data lookup procedures on a data management platform.

12. The system of claim 1, wherein the content server initiates one or more data lookup procedures on a network address-based geographic locator.

13. A method for dynamically serving content to a client computer system, the method comprising:
receiving a request for a content data element from the client computer system;
generating a tag list from the received request for the content data element, the tag list including at least one tag;
transmitting an initial query including the initial tag list to a data correlation server, in response to the initial query, the data correlation server generating one or more data lookup procedures;
initiating the execution of the one or more data lookup procedures, at least one of the data lookup procedures being executed on an event collection server with one or more event occurrence data elements retrievable thereby, the one or more data lookup procedures returning data convertible to one or more tags for storage on the tag list, with at least one of the tags being derived from the one or more event occurrence data elements;
transmitting the tag list to the data correlation server, one or more content data facts being generated thereby based upon a correlation of specific predefined combinations of the tags in the tag list thereto;
retrieving content data elements corresponding to the one or more content data facts; and
transmitting at least one of the content data elements to the client computer system.

14. The method of claim 13, further comprising:
appending data associated with one of the tags in the tag list to the content data element transmitted to the client computer system.

15. The method of claim 13, further comprising:
appending a data update client to the content data element transmitted to the client computer system, the data update client being executable on the client computer system for communication with the events collection server, the content data element transmitted to the client computer system being modified by the data update client in response to an update to the one or more event occurrence data elements received thereby from the events collection server.

16. The method of claim 13, further comprising:
excluding selected ones of the at least one content data element for transmission to the client computer system based upon an evaluation of secondary conditions associated therewith.

17. The method of claim 13, further comprising:
assigning a confidence level to the tag generated from the received request for the content data element.

18. The method of claim 13, wherein one of the data lookup procedures is executed on a data management platform to retrieve aggregated audience data associated with one or more advertising campaigns.

19. The system of claim 13, wherein one of the data lookup procedures is executed on a network address-based geographic locator to retrieve location information of a user of the client computer system.

20. An article of manufacture comprising a non-transitory program storage medium readable by a server computer system, the medium tangibly embodying one or more programs of instructions executable by the device to perform a method for dynamically serving digital content to a client computer system, the method comprising:
receiving a request for a content data element from the client computer system;
generating a tag list from the received request for the content data element, the tag list including at least one tag;
transmitting an initial query including the initial tag list to a data correlation server, in response to the initial query, the data correlation server generating one or more data lookup procedures;
executing the one or more data lookup procedures, at least one of the data lookup procedures being executed on an event collection server with one or more event occurrence data elements retrievable thereby, the one or more data lookup procedures returning one or more tags for storage on the tag list, with at least one of the tags being derived from the one or more event occurrence data elements;
transmitting the tag list to the data correlation server, one or more content data facts being generated thereby based upon a correlation of specific predefined combinations of the tags in the tag list thereto;
retrieving content data elements corresponding to the one or more content data facts; and
transmitting at least one of the content data elements to the client computer system.
